(19) United States
(12) Patent Application Publication
(10) Pub. No.: US 2026/0260819 A1
(43) Pub. Date: Sep. 3, 2026

(54) MULTILAYER ELECTRONIC COMPONENT

(71) Applicant: SAMSUNG ELECTRO-MECHANICS CO., LTD., Suwon-si (KR)

(72) Inventors: Seung Yeon LEE, Suwon-si (KR); Han Sol YUN, Suwon-si (KR); Seo Ho LEE, Suwon-si (KR); Berm Ha CHA, Suwon-si (KR)

(73) Assignee: SAMSUNG ELECTRO-MECHANICS CO., LTD., Suwon-si (KR)

(21) Appl. No.: 19/438,368

(22) Filed: Dec. 31, 2025

(30) Foreign Application Priority Data
Feb. 28, 2025 (KR) 10-2025-0026325

(51) Int. Cl. H01G 4/30; H01G 4/012

(52) U.S. Cl. CPC H01G 4/30; H01G 4/012

(57) ABSTRACT

A multilayer electronic component includes a body including a dielectric layer, a first internal electrode and a second internal electrode alternately arranged with the dielectric layer interposed therebetween; and external electrodes disposed on the body and connected to the first internal electrode and the second internal electrode, wherein the body further includes a first dummy electrode disposed between the first internal electrode and a surface of the body and a second dummy electrode disposed between the second internal electrode and the surface of the body and spaced apart from the first dummy electrode, the first dummy electrode is disposed closer to a surface of the body than the first internal electrode, and the second dummy electrode is disposed closer to a surface of the body than the second internal electrode.

### CROSS-REFERENCE TO RELATED APPLICATION(S)

This application claims benefit of priority to Korean Patent Application No. 10-2025-0026325 filed on February 28, 2025 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type capacitor mounted on the printed circuit boards of various types of electronic products, such as imaging devices including liquid crystal displays (LCDs) and plasma display panels (PDPs), computers, smartphones, cell phones, onboard chargers (OBCs) and DC-DC converters for electric vehicles, and the like to allow electricity to be charged therein and discharged therefrom.

During operation, MLCCs may generate heat due to the flow of current, and excessive heat may accumulate inside MLCCs, both in small, high-capacity IT devices and in electrical devices operating in high-voltage, high-temperature environments. The accumulated heat may reduce the lifespan and reliability of MLCCs.

Conventionally, increasing the thickness of internal electrodes has been used to improve heat dissipation within MLCCs. In this case, however, a step difference may occur depending on the presence or absence of internal electrode patterns, which may cause the internal electrode edges to warp, potentially leading to cracks in MLCCs.

Therefore, there is a need to improve structural features that may efficiently dissipate heat generated within MLCCs to suppress the occurrence of cracks in MLCCs, while securing the lifespan and reliability of MLCCs.

### SUMMARY

An aspect of the present disclosure is to efficiently dissipate heat generated within a multilayer electronic component.

Another aspect of the present disclosure is to suppress the occurrence of cracks in a multilayer electronic component.

However, the problems to be solved by the present disclosure are not limited to the aforementioned contents and will be more readily understood in describing specific example embodiments of the present disclosure.

An aspect of the present disclosure is to provide a multilayer electronic component includes: a body including a dielectric layer, a first internal electrode and a second internal electrode alternately arranged with the dielectric layer interposed therebetween, a first surface and a second surface facing each other in a first direction in which the first internal electrode and the second internal electrode are arranged with the dielectric layer interposed therebetween, a third surface and a fourth surface connected to the first surface and the second surface and facing each other in a direction, perpendicular to the first direction, and a fifth surface and a sixth surface connected to the first surface to the fourth surface and facing each other in a direction, perpendicular to the first and second directions; and external electrodes disposed on the body and connected to the first internal electrode and the second internal electrode, wherein the body further includes a first dummy electrode disposed between the first internal electrode and a surface of the body and a second dummy electrode disposed between the second internal electrode and the surface of the body and spaced apart from the first dummy electrode, the first dummy electrode is disposed closer to the fourth surface, the fifth surface, and the sixth surface than the first internal electrode, and the second dummy electrode is disposed closer to the third surface, the fifth surface, and the sixth surface than the second internal electrode.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a cross-sectional view taken along line I-I of FIG. 1;

FIG. 3 is a cross-sectional view taken along line II-II of FIG. 1;

FIGS. 4A and 4B are plan views illustrating a configuration of internal electrodes and dummy electrodes according to an example embodiment;

FIG. 5 is an enlarged view of region P of FIG. 3; and

FIG. 6 is an exploded perspective view of a body according to an example embodiment.

### DETAILED DESCRIPTION

Hereinafter, example embodiments of the present disclosure will be described in detail with reference to the accompanying drawings. The present disclosure may, however, be exemplified in many different forms and should not be construed as being limited to the specific example embodiments set forth herein. Rather, these example embodiments are provided so that this disclosure will be thorough and complete, and will fully convey the scope of the present disclosure to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, the X-direction may refer to a thickness direction, the Y-direction may refer to a length direction, and the Z-direction may refer to a width direction. A stacking direction of internal electrodes or dielectric layers may be either the thickness direction or the width direction.

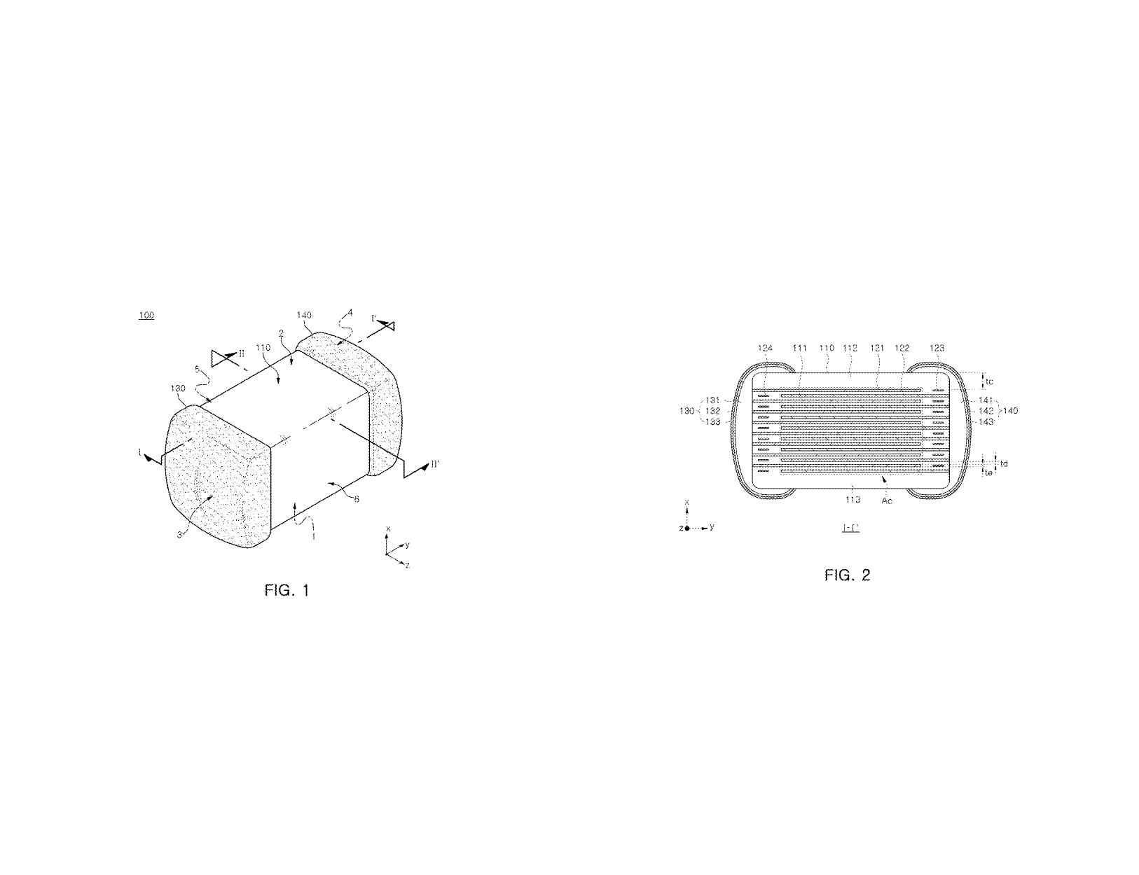

FIG. 1 is a schematic perspective view of a multilayer electronic component according to an example embodiment of the present disclosure.

FIG. 2 is a cross-sectional view taken along line I-I of FIG. 1.

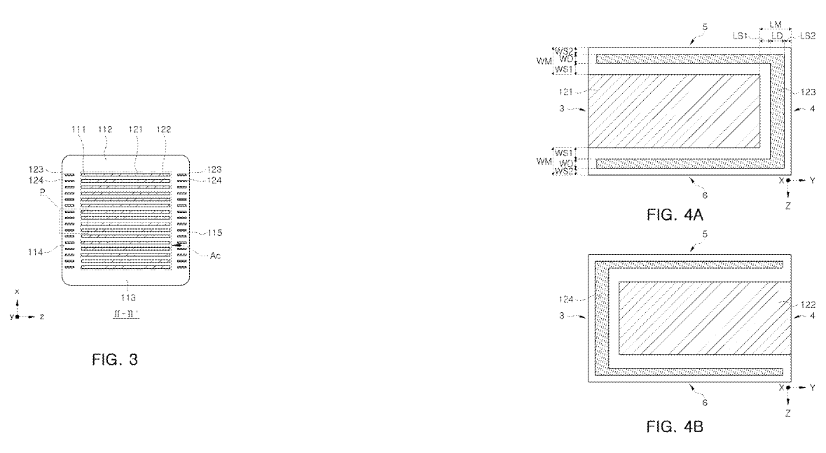

FIG. 3 is a cross-sectional view taken along line II-II of FIG. 1.

FIGS. 4A and 4B are plan views illustrating a configuration of internal electrodes and dummy electrodes according to an example embodiment.

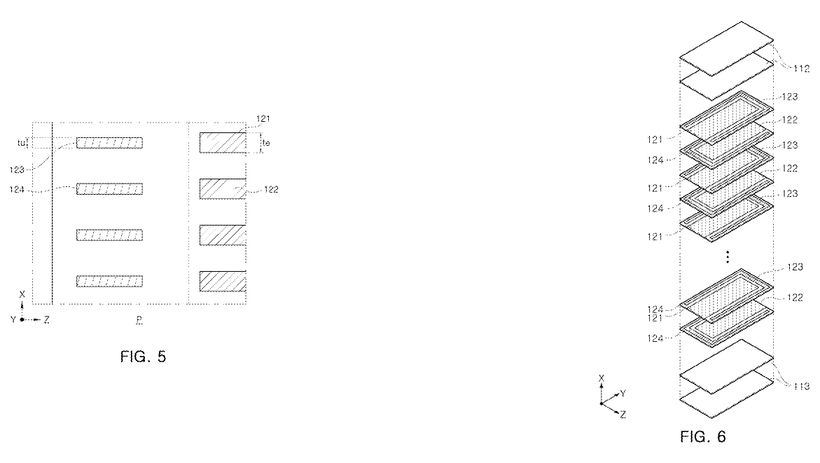

FIG. 5 is an enlarged view of region P of FIG. 3.

FIG. 6 is an exploded perspective view of a body according to an example embodiment.

Hereinafter, a multilayer electronic component 100 according to an example embodiment of the present disclosure and an example embodiment thereof will be described in detail with reference to FIGS. 1 through 6.

The multilayer electronic component 100 according to an example embodiment of the present disclosure includes a body 110. The body 110 includes a dielectric layer 111, a first internal electrode 121, and a second internal electrode 122 with the first internal electrode 121 and the second internal electrode 122 alternately arranged with the dielectric layer 111 interposed therebetween. As illustrated, the body 110 includes a plurality of dielectric layers 111, a plurality of first internal electrodes 121, and a plurality of second internal electrodes 122. The body 110 further includes a first surface 1 and a second surface 2 facing each other in a first direction in which the first internal electrode 121 and the second internal electrode 122 are arranged with the dielectric layer 111 interposed therebetween. The body 110 further includes a third surface 3 and a fourth surface 4 connected to the first surface 1 and the second surface 2 and facing each other in a direction, perpendicular to the first direction. The body 110 further includes a fifth surface 5 and a sixth surface 6 connected to the first surface to the fourth surface 1, 2, 3, and 4 and facing each other in a direction, perpendicular to the first and second directions. The body 110 further includes external electrodes 130 and 140 disposed on the body 110 and connected to the first internal electrode 121 and the second internal electrode 122, wherein the body 110 further includes a first dummy electrode 123 disposed between the first internal electrode 121 and a surface of the body 110, and a second dummy electrode 124 disposed between the second internal electrode 122 and the surface of the body 110 and spaced apart from the first dummy electrode 123. The first dummy electrode 123 may be disposed closer to the fourth surface 4, the fifth surface 5, and the sixth surface 6 than the first internal electrode 121. The second dummy electrode 124 may be disposed closer to the third surface 3, the fifth surface 5, and the sixth surface 6 than the second internal electrode 122.

Referring to FIG. 2, the body 110 may include the dielectric layer 111, and the first internal electrode 121 and the second internal electrode 122 alternately arranged with the dielectric layer 111 interposed between.

While there are no specific limitations on the specific shape of the body 110, as illustrated, the body 110 may be formed in a hexahedral shape or a similar shape. Due to shrinkage of the ceramic powder included in the body 110 during a sintering process, the body 110 may not have a perfectly straight hexahedral shape but may have a substantially hexahedral shape.

The body 110 may have the first and second surfaces 1 and 2 facing each other in the first direction, third and fourth surfaces 3 and 4 connected to the first and second surfaces 1 and 2 and facing each other in the second direction, and fifth and sixth surfaces 5 and 6 connected to the first and second surfaces 1 and 2, connected to the third and fourth surfaces 3 and 4, and facing each other in a third direction. Here, the first direction may refer to a direction in which the first internal electrode 121 and the second internal electrode 122 are arranged with the dielectric layer 111 interposed therebetween, but the present disclosure is not limited thereto, and the direction in which the first internal electrode 121 and the second internal electrode 122 are arranged with the dielectric layer 111 interposed therebetween may be the second direction or the third direction.

The dielectric layer 111 included in the body 110 may include a plurality of layers. In a sintered state, the dielectric layers 111 may be integrated such that that boundaries therebetween are difficult to identify without a scanning electron microscope (SEM). The number of stacked dielectric layers 111 is not particularly limited and may be determined based on the size of the multilayer electronic component 100. For example, the body 110 may be formed by stacking 400 or more dielectric layers 111.

The dielectric layer 111 may be formed by preparing a ceramic slurry including ceramic powder, an organic solvent, and a binder, applying the slurry onto a carrier film and drying the same to form a ceramic green sheet, and then sintering the ceramic green sheet. The ceramic powder is not particularly limited as long as it may achieve sufficient capacitance. For example, barium titanate (BaTiO₃)-based powder may be used as ceramic powder. For a more specific example, the barium titanate (BaTiO₃)-based powder may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1).

Meanwhile, since the dielectric layer 111 is in a sintered state, the ceramic powder used as the material for the dielectric layer 111 may form grain boundaries with dielectric grains.

An average thickness td of the dielectric layer 111 may be arbitrarily set depending on the desired characteristics or purposes. For a specific example, the average thickness td of the dielectric layer 111 may be 300 nm or more and 10 μm or less. In addition, at least one of the plurality of dielectric layers 111 may have an average thickness td of 300 nm or more and 10 μm or less.

The average thickness td of the dielectric layer 111 may be a value obtained by dividing a dielectric layer 111 in the length direction into four equal parts, based on one dielectric layer 111 adjacent to a point at which a longitudinal central line of a capacitance formation portion that will be described in further detail below and a thicknesswise central line of the capacitance formation portion intersect, among dielectric layers 111 extracted from an image obtained by scanning a cross-section of the body 110 in the first and second directions polished to a central portion of the body 110 in the third direction using a scanning electron microscope (SEM), measuring thicknesses at 1/4, 2/4, and 3/4 points of the dielectric layer 111, and averaging the measured thicknesses. The average thickness td of the dielectric layer 111 may be further generalized by extending such measurement to the two upper and two lower dielectric layers 111, each spaced equally apart, based on one dielectric layer 111 adjacent to the point at which the longitudinal central line of the capacitance formation portion and the thicknesswise central line of the capacitance formation portion intersect.

The internal electrodes 121 and 122 may be arranged alternately in the first direction with the dielectric layer 111 interposed therebetween.

The internal electrodes 121 and 122 may include first and second internal electrodes 121 and 122. The first and second internal electrodes 121 and 122 may be alternately arranged to face each other with the dielectric layer 111 forming the body 110 interposed therebetween and may be connected to the third and fourth surfaces 3 and 4 of the body 110, respectively. Specifically, one end of the first internal electrode 121 may be connected to the third surface 3, and one end of the second internal electrode 122 may be connected to the fourth surface 4. That is, in an example embodiment, the internal electrodes 121 and 122 may be in contact with the third surface 3 or the fourth surface 4.

As illustrated in FIGS. 4A and 4B, the first internal electrode 121 may be spaced apart from the fourth surface 4 and exposed through the third surface 3, while the second internal electrode 122 may be spaced apart from the third surface 3 and exposed through the fourth surface 4. A first external electrode 130 may be disposed on the third surface 3 of the body 110 and connected to the first internal electrode 121, and a second external electrode 140 may be disposed on the fourth surface 4 of the body 110 and connected to the second internal electrode 122.

That is, the first internal electrode 121 may be connected to the first external electrode 130 without being connected to the second external electrode 140, and the second internal electrode 122 may be connected to the second external electrode 140 without being connected to the first external electrode 130. Accordingly, the first internal electrode 121 may be formed at a predetermined distance from the fourth surface 4, and the second internal electrode 122 may be formed at a predetermined distance from the third surface 3. Here, the first and second internal electrodes 121 and 122 may be electrically separated from each other by the dielectric layer 111 disposed therebetween.

The material forming the internal electrodes 121 and 122 is not particularly limited, and any material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), or alloys thereof.

In addition, the internal electrodes 121 and 122 may be formed by printing a conductive paste for internal electrodes 121 and 122 including one or more of nickel (Ni), copper (Cu), palladium (Pd), silver (Ag), gold (Au), platinum (Pt), tin (Sn), tungsten (W), titanium (Ti), or alloys thereof onto a ceramic green sheet. A printing method for the conductive paste for internal electrodes 121 and 122 may be screen-printing or gravure printing, but the present disclosure is not limited thereto.

An average thickness te of the internal electrodes 121 and 122 is not particularly limited and may be arbitrarily set depending on the desired characteristics or purposes. For example, the average thickness te of the internal electrodes 121 and 122 may be 300 nm or greater and 10 μm or less. In addition, the average thickness te of at least one of the plurality of internal electrodes 121 and 122 may be 300 nm or greater and 10 μm or less.

The average thickness te of the internal electrodes 121 and 122 may be a value obtained by dividing an internal electrode 121, 122 in the length direction into four equal parts, based on one internal electrode 121, 122 adjacent to a point at which a longitudinal central line of the capacitance formation portion and a thicknesswise central line of the capacitance formation portion intersect, among internal electrodes 121 and 122 extracted from an image obtained by scanning a cross-section of the body 110 in the first and second directions polished to a central portion of the body 110 in the third direction using a scanning electron microscope (SEM), measuring thicknesses at 1/4, 2/4, and 3/4 points of the internal electrode 121, 122, and averaging the measured thicknesses. The average thickness te of the internal electrode 121, 122 may be further generalized by extending such measurement to the two upper and two lower internal electrodes 121 and 122, each spaced equally apart, based on one internal electrode 121, 122 adjacent to the point at which the longitudinal central line of the capacitance formation portion and the thicknesswise central line of the capacitance formation portion intersect.

Referring to FIGS. 2 and 3, the body 110 may include a capacitance formation portion Ac formed within the body 110 and forming capacitance by including the first internal electrode 121 and the second internal electrode 122 disposed to face each other with the dielectric layer 111 interposed therebetween and cover portions 112 and 113 formed on the upper and lower sides of the capacitance formation portion Ac in the first direction.

In addition, the capacitance formation portion Ac is a portion contributing to the capacitance formation of the capacitor and may be formed by repeatedly stacking a plurality of first and second internal electrodes 121 and 122 with the dielectric layer 111 interposed therebetween.

The cover portions 112 and 113 may be formed by stacking a single dielectric layer 111 or two or greater dielectric layers 111 on the upper and lower surfaces of the capacitance formation portion Ac in the thickness direction, respectively, and fundamentally serve to prevent damage to the internal electrodes 122 and 122 due to physical or chemical stress.

The cover portions 112 and 113 may not include internal electrodes 121 and 122 and may include the same material as that of the dielectric layer 111, for example, a barium titanate (BaTiO₃)-based ceramic material.

Meanwhile, an average thickness tc of the cover portions 112 and 113 need not be particularly limited. For example, the average thickness tc of the cover portions 112 and 113 may range from 10 to 300 μm. However, to facilitate miniaturization and high capacitance of multilayer electronic components 100, the average thickness tc of the cover portions 112 and 113 may be 15 μm or less.

The average thickness tc of the cover portions 112 and 113 may refer to the size in the first direction and may be a value obtained by averaging sizes of the cover portions 112 and 113 in the first direction measured at five equally spaced points above or below the capacitance formation portion Ac.

Referring to FIG. 3, margin portions 114 and 115 may be arranged on both sides of the capacitance formation portion Ac in the third direction.

The margin portions 114 and 115 may include a first margin portion 114 disposed on the fifth surface 5 of the body 110 and a second margin portion 115 disposed on the sixth surface 6. In other words, the margin portions 114 and 115 may be arranged on both end surfaces of the body 110 in the width direction (e.g., the fifth and the sixth surfaces 5 and 6).

As illustrated in FIG. 3, the margin portions 114 and 115 may refer to regions between both ends of the first and second internal electrodes 121 and 122 and the boundary of the body 110 in a cross-section of the body 110 cut in the width-thickness direction.

The margin portions 114 and 115 may fundamentally serve to prevent damage to the internal electrodes 121 and 122 due to physical or chemical stress.

The margin portions 114 and 115 may be formed by forming the internal electrodes 121 and 122 by applying a conductive paste to a ceramic green sheet, excluding a region in which the margin portions 114 and 115 are to be formed.

In addition, to suppress a step difference caused by the internal electrodes 121 and 122, after stacking, cutting may be performed such that the internal electrodes 121 and 122 are exposed to the fifth and sixth surfaces 5 and 6 of the body 110, and then, a single dielectric layer 111 or two or greater dielectric layers 111 may be stacked on both sides of the capacitance formation portion Ac in the third direction (e.g., the width direction) to form the margin portions 114 and 115.

Meanwhile, the width of the margin portions 114 and 115 need not be specifically limited. For example, the width of the margin portions 114 and 115 may range from 5 to 300 μm. However, to facilitate miniaturization and high-capacitance of multilayer electronic components 100, the average width of the margin portions 114 and 115 may be 15 μm or less.

The average width of the margin portions 114 and 115 may refer to the average size in the third direction of the region in which the internal electrode 121 or 122 is spaced apart from the fifth surface 5 and the average size in the third direction of the region in which the internal electrode 121 or 122 is spaced apart from the sixth surface 6 and may be the average of the size of the margin portions 114 and 115 in the third direction measured at five equally spaced points on a side surface of the capacitance formation portion Ac.

Referring to FIG. 1, the external electrodes 130 and 140 may be arranged on the third surface 3 and the fourth surface 4 of the body 110.

The external electrodes 130 and 140 may be arranged on the third and fourth surfaces 3 and 4 of the body 110, respectively, and may be connected to the first and second internal electrodes 121 and 122, respectively.

In the present example embodiment, the multilayer electronic component 100 having two external electrodes 130 and 140 is described. However, the number and shape of the external electrodes 130 and 140 may vary depending on the shape of the internal electrodes 121 and 122 or other purposes.

Meanwhile, the external electrodes 130 and 140 may be formed using any material having electrical conductivity, such as metal, and a specific material may be determined by considering electrical characteristics, structural stability, and the like. Furthermore, the external electrodes 130 and 140 may have a multilayer structure.

For example, the external electrodes 130 and 140 may include electrode layers 131 and 141 arranged on the body 110 and plating layers 132, 133, 142, and 143 arranged on the electrode layers 131 and 141.

More specifically, the electrode layers 131 and 141 may be fired electrodes including a conductive metal and glass or resin-based electrodes including a conductive metal and resin.

Furthermore, the electrode layers 131 and 141 may be formed by sequentially forming fired electrodes and resin-based electrodes on the body 110. Also, the electrode layers 131 and 141 may be formed by transferring a sheet including a conductive metal onto the body 110 or by transferring a sheet including a conductive metal onto a fired electrode. Furthermore, the electrode layers 131 and 141 may be formed as plating layers or may be layers by using a deposition method, such as sputtering or atomic layer deposition (ALD).

The conductive metal included in the electrode layers 131 and 141 may be any material having excellent electrical conductivity and is not particularly limited. For example, the conductive metal may be one or more of nickel (Ni), copper (Cu), or alloys thereof.

The plating layers 132, 133, 142, and 143 serve to improve mounting characteristics. The type of plating layer 132, 133, 142, and 143 is not particularly limited, may include one or more of Ni, Sn, Pd, or alloys thereof, and may include a plurality of layers.

In a more specific example, the plating layers 132, 133, 142, and 143 may be Ni plating layers or Sn plating layers. The Ni plating layers and the Sn plating layers may be sequentially formed on the electrode layer 131, 141, or a Sn plating layer, a Ni plating layer, and a Sn plating layer may be sequentially formed. Furthermore, the plating layers 132, 133, 142, and 143 may include a plurality of Ni plating layers and/or a plurality of Sn plating layers. In addition, the plating layers 132, 133, 142, and 143 may be formed sequentially as Ni and Pd plating layers on the electrode layers 131 and 141.

The size of the multilayer electronic component 100 need not be particularly limited. According to the present disclosure, since the multilayer electronic component 100 is advantageous for miniaturization and high capacitance, the multilayer electronic component 100 may be applied to small IT products, and since the multilayer electronic component 100 ensures high reliability in various environments, the multilayer electronic component 100 may also be applied to automotive electronics products requiring high reliability.

Referring to FIGS. 2 through 4, the body 110 may further include the first dummy electrode 123 disposed between the first internal electrode 121 and the fourth surface 4, the fifth surface 5, and the sixth surface 6, and the second dummy electrode 124 disposed between the second internal electrode 122 and the third surface 3, the fifth surface 5, and the sixth surface 6 and spaced apart from the first dummy electrode 123.

Conventionally, methods for increasing the thickness of internal electrodes have been used to improve heat generation within multilayer electronic components. In this case, a step difference may occur depending on the presence or absence of internal electrodes. This step difference may warp the ends of the internal electrodes 121 and 122 and the dielectric layer 111 adjacent to the margin portions 114 and 115 of the body 110, potentially causing cracks in the multilayer electronic component 100.

Accordingly, in an example embodiment of the present disclosure, by arranging the dummy electrodes 123 and 124 in the margin portions 114 and 115 between the internal electrodes 121 and 122 and the surface of the body 110, a heat dissipation path may be formed to dissipate heat generated inside the body 110 to the outside of the body 110. Heat generated inside the body 110 may be efficiently dissipated to the outside without excessively increasing the thickness te of the internal electrodes 121 and 122.

Meanwhile, the warping of the ends of the internal electrodes 121 and 122 and the ends of the dielectric layer 111 due to the step difference may become more severe toward the surface of the body 110. However, according to an example embodiment of the present disclosure, since the first dummy electrode 123 is disposed closer to the fourth surface 4, the fifth surface 5, and the sixth surface 6 than the first internal electrode 121, and the second dummy electrode 124 is disposed closer to the third surface 3, the fifth surface 5, and the sixth surface 6 than the second internal electrode 122, the step difference reduction effect may be further enhanced, and a phenomenon of cracks concentrating at the ends of the dielectric layer 111 close to the surface of the body 110 may be further mitigated.

Referring to FIGS. 4A and 4B, in an example embodiment, the first dummy electrode 123 may be disposed to surround at least a portion of the first internal electrode 121, and the second dummy electrode 124 may be disposed to surround at least a portion of the second internal electrode 122. Through this, heat generated by the internal electrodes 121 and 122 may be dissipated through the third to sixth surfaces 3, 4, 5, and 6 of the body 110, thereby further enhancing the heat dissipation effect of the present disclosure.

Referring to FIGS. 4A and 4B, in an example embodiment, the first dummy electrode 123 may be continuously disposed between the first internal electrode 121 and the fourth surface 4, the fifth surface 5, and the sixth surface 6, and the second dummy electrode 124 may be continuously disposed between the second internal electrode 122 and the third surface 3, the fifth surface 5, and the sixth surface 6. Through this, heat generated by the internal electrodes 121 and 122 may be dissipated through the third to sixth surfaces 3, 4, 5, and 6 of the body 110, so that the heat dissipation effect of the present disclosure may be further improved.

Referring to FIGS. 4A and 4B, in an example embodiment, the first and second dummy electrodes 123 and 124 may have different lengths and widths. Specifically, a width WD of a region of the first dummy electrode 123 disposed between the first internal electrode 121 and the fifth surface 5 and sixth surface 6 in the third direction may be smaller than a length LD of a region of the first dummy electrode 123 disposed between the first internal electrode 121 and the fourth surface 4. Through this, heat generated by the first internal electrode 121 may be more efficiently dissipated to the region adjacent to the first external electrode 130 including a conductive metal.

Similarly, a width of a region of the second dummy electrode 124 disposed between the second internal electrode 122 and the fifth surface 5 and the sixth surface 6 in the third direction may be smaller than a length of a region of the second dummy electrode 124 disposed between the second internal electrode 122 and the third surface 3 in the second direction.

Referring to FIGS. 4A and 4B, in an example embodiment, when a width of a region of the first dummy electrode 123 disposed between the first internal electrode 121 and the fifth surface 5 and the sixth surface 6 in the third direction is WD and a distance between the first internal electrode 121 and the fifth surface 5 and the sixth surface 6 in the third direction is WM, WD/WM may satisfy a value of 0.05 or more and less than 1. If WD/WM is less than 0.05, the step difference reduction effect and heat dissipation effect according to the present disclosure may be somewhat insufficient. While there is no need to limit an upper limit of WD/WM, since the first dummy electrode 123 and the first internal electrode 121 may be arranged to be spaced apart from each other in the third direction, WD/WM may be less than 1.

Meanwhile, the aforementioned correlation between WD and WM may also be applied between the second dummy electrode 124 and the second internal electrode 122.

In an example embodiment, when a distance between the first internal electrode 121 and the first dummy electrode 123 in the third direction is WS1 and a distance between the first dummy electrode 123 and the fifth surface 5 or sixth surface 6 in the third direction is WS2, WS1 > WS2 may be satisfied. Accordingly, by arranging the first dummy electrode 123 closer to the fifth surface 5 or sixth surface 6 than to the first internal electrode 121, the effect of reducing a step difference in the third direction may be further enhanced.

In an example embodiment, WS1 and WS2 may be 30 μm or greater and less than 100 μm. Accordingly, by sufficiently forming the first dummy electrode 123 in the margin portion 114, 115 in which the first internal electrode 121 is not formed in the third direction, the heat dissipation characteristics of the multilayer electronic component 100 may be improved, a step difference reduction effect may be achieved, and overlapping of the first internal electrode 121 and the first dummy electrode 123 may be prevented.

Meanwhile, the aforementioned correlation between WS1 and WS2 may also be applied between the second dummy electrode 124 and the second internal electrode 122.

In an example embodiment, when a length of a region of the first dummy electrode 123 disposed between the first internal electrode 121 and the fourth surface 4 is LD and a distance between the first internal electrode 121 and the fourth surface 4 in the second direction is LM, LD/LM may satisfy a value of 0.05 or greater and less than 1. If LD/LM is less than 0.05, the step difference reduction effect and heat dissipation effect of the present disclosure may be somewhat insufficient. While there is no need to limit an upper limit of LD/LM, since the first dummy electrode 123 and the first internal electrode 121 may be arranged to be spaced apart from each other in the second direction, LD/LM may be less than 1.

Meanwhile, the aforementioned correlation between LD and LM may also be applied between the second dummy electrode 124 and the second internal electrode 122.

In an example embodiment, when a distance between the first internal electrode 121 and the first dummy electrode 123 in the second direction is LS1 and a distance between the first dummy electrode 123 and the fourth surface 4 in the second direction is LS2, LS1 > LS2 may be satisfied. Accordingly, by positioning the first dummy electrode 123 closer to the fourth surface 4 than the first internal electrode 121, the effect of reducing the step difference in the second direction may be further enhanced.

In an example embodiment, LS1 and LS2 may be 30 μm or greater and less than 100 μm. Accordingly, by sufficiently forming the first dummy electrode 123 in the margin portion 114, 115 in which the first internal electrode 121 is not formed in the second direction, the heat dissipation characteristics of the multilayer electronic component 100 may be improved, the step difference reduction effect may be achieved, and overlapping of the first internal electrode 121 and the first dummy electrode 123 may be prevented.

Meanwhile, the aforementioned correlation between LS1 and LS2 may also be applied between the second dummy electrode 124 and the second internal electrode 122.

The aforementioned WD, WM, WS1, and WS2 may be measured by averaging the values measured from two upper and two lower dummy electrodes 123 and 124 at equal intervals based on the dummy electrode 123, 124 disposed in the center in the first direction in an image of a first and third direction cross-section polished to a second direction center of the multilayer electronic component 100 or a second and third direction cross-section polished until the dummy electrodes 123 and 124 are exposed, scanned by a scanning electron microscope (SEM) or an optical microscope (OM), or by averaging the values measured from two left and two right regions at equal intervals based on a second direction center of the dummy electrode 123, 124, but is not limited thereto.

The aforementioned LD, LM, LS1, and LS2 may be measured by averaging the values measured from two upper and two lower dummy electrodes 123 and 124 at equal intervals based on the dummy electrode 123, 124 disposed in the center in the first direction in an image of a first and second direction cross-section polished to a third direction center of the multilayer electronic component 100 or a second and third direction cross-section polished until the dummy electrodes 123 and 124 are exposed, scanned by a scanning electron microscope (SEM) or an optical microscope (OM), or by averaging the values measured from two upper and two lower regions at equal intervals based on a third direction center of the dummy electrode 123, 124, but is not limited thereto.

In an example embodiment, the distance between the first dummy electrode 123 and the third surface 3 in the second direction and the distance between the second dummy electrode 124 and the third surface 4 in the second direction may be 30 μm or more and less than 100 μm. Accordingly, the heat dissipation characteristics of the multilayer electronic component 100 may be improved, a step difference reduction effect may be achieved, and the dummy electrodes 123 and 124 may be prevented from being exposed to the outside of the body 110.

In an example embodiment, the first dummy electrode 123 may be disposed on the same dielectric layer 111 as the first internal electrode 121, and the second dummy electrode 124 may be disposed on the same dielectric layer 111 as the second internal electrode 122. Accordingly, the heat dissipation paths between the dummy electrodes 123 and 124 and the internal electrodes 121 and 122 may be reduced, thereby further improving the heat dissipation characteristics.

The first dummy electrode 123 and the second dummy electrode 124 may be disposed spaced apart from the third surface through the sixth surface 3, 4, 5, and 6. Accordingly, short circuits between the dummy electrodes 123 and 124 and the external electrodes 130 and 140 may be prevented, and the problem of reduced moisture resistance reliability of the multilayer electronic component 100 due to exposure of the dummy electrodes 123 and 124 to the surface of the body 110 may also be prevented or mitigated.

Referring to FIG. 5, in an example embodiment, when the average thickness of the first and second internal electrodes 121 and 122 is te, and the average thickness of the first and second dummy electrodes 123 and 124 is tu, te > tu may be satisfied. If the proportion of the first and second dummy electrodes 123 and 124 in the multilayer electronic component 100 is excessive, the dielectric ceramic component of the body 110 may be insufficient, resulting in a decrease in the interlayer adhesive strength of the dielectric layer 111, thereby deteriorating the mechanical strength of the multilayer electronic component 100. Therefore, in an example embodiment, by satisfying te > tu, even when the first and second dummy electrodes 123 and 124 are formed, a sufficient proportion of the dielectric ceramic component in the body 110 may be secured, thereby alleviating the phenomenon of deterioration in the mechanical strength of the multilayer electronic component 100.

The aforementioned tu may be measured by averaging the values measured from two upper regions and two lower regions based on the dummy electrode 123, 124 disposed at the center in the first direction in an image of the first and third direction cross-section of the multilayer electronic component 100 polished to the center of the multilayer electronic component 100 in the second direction, scanned using a scanning electron microscope (SEM) or an optical microscope (OM), but is not limited thereto.

In an example embodiment, the first and second dummy electrodes 123 and 124 may include an oxide including a conductive metal. Specifically, the first and second dummy electrodes 123 and 124 may include one or more of a conductive metal and an oxide of the conductive metal.

A greater content of the conductive metal included in the first and second dummy electrodes 123 and 124 may be advantageous for improving heat dissipation characteristics, and a greater content of the oxide of the conductive metal included in the first and second dummy electrodes 123 and 124 may improve the bonding strength between the dielectric layer 111 and the first and second dummy electrodes 123 and 124.

The type of conductive metal included in the first and second dummy electrodes 123 and 124 is not particularly limited. However, in an example embodiment, the conductive metal may include one or more of nickel (Ni), silver (Ag), aluminum (Al), and copper (Cu).

In an example embodiment, the ratio of the content of oxygen to the content of the conductive metal included in the first and second dummy electrodes 123 and 124 may be 0.5 at% or more and 10 at% or less. Accordingly, the effect of improving the heat dissipation characteristics of the multilayer electronic component 100 and the effect of securing interlayer bonding strength between the dielectric layer 111 and the first and second dummy electrodes 123 and 124 may be simultaneously achieved.

The contents of conductive metal and oxygen of the first and second dummy electrodes 123 and 124 may be analyzed in a cross-section of the multilayer electronic component 100 taken in the first and second direction and polished to the second direction center of the multilayer electronic component 100 by using the energy dispersive X-ray spectroscopy (EDS) mode of a scanning electron microscope (SEM), the EDS mode of a transmission electron microscope (TEM), or the EDS mode of a scanning transmission electron microscope (STEM). First, a thinned analysis sample is prepared using a focused ion beam (FIB) device in a region to be measured. Also, a damage layer of a surface of the thinned sample is removed using xenon (Xe) or argon (Ar) ion milling. Thereafter, each component to be measured is mapped from the images obtained using SEM-EDS, TEM-EDS, or STEM-EDS, and a qualitative/quantitative analysis is performed. In this case, the qualitative/quantitative analysis graph for each component may be expressed in terms of the content of each element, for example, in mass percentage (wt%), atomic percentage (at%), or molar percentage (mol%) and may also represent the content of a specific component relative to the content of another specific component.

Referring to FIG. 6, the first dummy electrode 123 may be formed in each layer in which the first internal electrode 121 is formed, and the second dummy electrode 124 may be formed in each layer in which the second internal electrode 122 is formed. Accordingly, the heat dissipation characteristics of the multilayer electronic component 100 may be further enhanced and the cracking prevention effect may be further enhanced.

One of the various effects of the present disclosure is the efficient dissipation of heat generated within the multilayer electronic component 100.

One of the various effects of the present disclosure is the suppression of cracking in the multilayer electronic component 100.

However, the various advantages and effects of the present disclosure are not limited to the aforementioned contents and will be more readily understood when describing specific example embodiments of the present disclosure.

Although the example embodiments or experimental examples of the present disclosure have been described in detail above, the present disclosure is not limited to the example embodiments described above and the accompanying drawings but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an example embodiment or an example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular example embodiments only and are not intended to limit the example embodiments. As used herein, the singular forms “a,” “an,” and “the” are intended to include the plural forms as well, unless the context clearly indicates otherwise.

What is claimed is:

1. A multilayer electronic component comprising:
a body including:
a dielectric layer,
a first internal electrode and a second internal electrode alternately arranged with the dielectric layer interposed therebetween,
a first surface and a second surface facing each other in a first direction in which the first internal electrode and the second internal electrode are arranged with the dielectric layer interposed therebetween,
a third surface and a fourth surface connected to the first surface and the second surface and facing each other in a direction, perpendicular to the first direction, and
a fifth surface and a sixth surface connected to the first surface to the fourth surface and facing each other in a direction, perpendicular to the first and second directions; and
external electrodes disposed on the body and connected to the first internal electrode and the second internal electrode,
wherein:
the body further includes a first dummy electrode disposed between the first internal electrode and a surface of the body and a second dummy electrode disposed between the second internal electrode and the surface of the body and spaced apart from the first dummy electrode,
the first dummy electrode is disposed closer to the fourth surface, the fifth surface, and the sixth surface than the first internal electrode, and
the second dummy electrode is disposed closer to the third surface, the fifth surface, and the sixth surface than the second internal electrode.

2. The multilayer electronic component according to claim 1, wherein the first dummy electrode is disposed to surround at least a portion of the first internal electrode, and the second dummy electrode is disposed to surround at least a portion of the second internal electrode.

3. The multilayer electronic component according to claim 1, wherein the first dummy electrode is continuously disposed between the first internal electrode and the fourth surface, the fifth surface, and the sixth surface, and the second dummy electrode is continuously disposed between the second internal electrode and the third surface, the fifth surface, and the sixth surface.

4. The multilayer electronic component according to claim 1, wherein a width of a region of the first dummy electrode disposed between the first internal electrode and the fifth surface and the sixth surface in a third direction is smaller than a length of a region of the first dummy electrode disposed between the first internal electrode and the fourth surface, and a width of a region of the second dummy electrode disposed between the second internal electrode and the fifth surface and the sixth surface in the third direction is smaller than a length of a region of the second dummy electrode disposed between the second internal electrode and the third surface in the second direction.

5. The multilayer electronic component according to claim 1, wherein WD/WM is 0.05 or more and less than 1 in which WD is a width of a region of the first dummy electrode disposed between the first internal electrode and the fifth surface and the sixth surface and WM is a distance between the first internal electrode and the fifth surface and the sixth surface in a third direction.

6. The multilayer electronic component according to claim 1, wherein LD/LM is 0.05 or more and less than 1 in which LD is a length of a region of the first dummy electrode disposed between the first internal electrode and the fourth surface in the second direction and LM is a distance between the first internal electrode and the fourth surface in the second direction.

7. The multilayer electronic component according to claim 1, wherein WS1 > WS2 in which WS1 is a distance between the first internal electrode and the first dummy electrode in a third direction and WS2 is a distance between the first dummy electrode and the fifth surface or the sixth surface in the third direction.

8. The multilayer electronic component according to claim 7, wherein WS1 and WS2 are 30 μm or more and less than 100 μm.

9. The multilayer electronic component according to claim 1, wherein LS1 > LS2 in which LS1 is a distance between the first internal electrode and the first dummy electrode in the second direction and LS2 is a distance between the first dummy electrode and the fourth surface in the second direction.

10. The multilayer electronic component according to claim 9, wherein LS1 and LS2 are 30 μm or more and less than 100 μm.

11. The multilayer electronic component according to claim 1, wherein the first dummy electrode is disposed on a same dielectric layer as that of the first internal electrode, and the second dummy electrode is disposed on a same dielectric layer as that of the second internal electrode.

12. The multilayer electronic component according to claim 1, wherein te > tu in which te is an average thickness of the first and second internal electrodes and tu is an average thickness of the first and second dummy electrodes.

13. The multilayer electronic component according to claim 1, wherein the first and second dummy electrodes include an oxide including a conductive metal.

14. The multilayer electronic component according to claim 13, wherein a ratio of a content of oxygen to a content of the conductive metal included in first and second heat dissipation patterns is 0.5 at% or more and 10 at% or less.
